(19) United States
(12) Patent Application Publication
(10) Pub. No.: US 2026/0004207 A1
(43) Pub. Date: Jan. 1, 2026

(54) TECHNIQUES FOR FACILITATING MULTI-AGENT AND HUMAN PROJECT MANAGEMENT AND COLLABORATION

(71) Applicant: Microsoft Technology Licensing, LLC, Redmond, WA (US)

(72) Inventor: Ryan Martin NADEL, Vancouver (CA)

(73) Assignee: Microsoft Technology Licensing, LLC, Redmond, WA (US)

(21) Appl. No.: 18/759,541

(22) Filed: Jun. 28, 2024

(51) Int. Cl. G06Q 10/0631; G06Q 10/10

(52) U.S. Cl. CPC G06Q 10/06313; G06Q 10/103

(57) ABSTRACT

A multi-agent and human project management and collaboration tool can provide the ability to create and manage projects and software agents in a cohesive framework. The collaboration tool can provide a multi-agent, multi-player channel where agents and humans work together to achieve an outcome. The collaboration tool can initiate a new project, where the objective is defined, and a team is dynamically built to achieve this objective. The team roles are parsed, and an agent is created for each role. Each agent is equipped with a personalized skillset and a working memory, allowing them to effectively collaborate with humans and each other to progress autonomously through the project stages. The agents can complete tasks based on the project plan and the results are stored in the agent's working memory. The project status is updated, and a report can be generated after each stage, providing a record of the project's progress.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Collaboration applications are software solutions designed to foster seamless teamwork and communication among individuals or groups, irrespective of their physical locations. Collaboration applications offer a range of features such as instant messaging, video conferencing, file sharing, and task management, enabling teams to coordinate efforts, share information, and work together on projects in real-time. Examples of collaboration applications include, but are not limited to, SLACK, MICROSOFT TEAMS, ZOOM, GOOGLE WORKSPACE, ASANA, TRELLO, JIRA, and CISCO WEBEX.

Collaboration applications tailored for project management serve as essential tools for organizing, coordinating, and tracking tasks and resources within a project team. These applications can offer a comprehensive suite of features designed to streamline project workflows and enhance team collaboration. Core functionalities can include task creation and assignment, milestone tracking, and progress monitoring through intuitive interfaces such as kanban boards, Gantt charts, or task lists. Communication features, such as instant messaging and video conferencing, facilitate real-time collaboration among team members, regardless of their physical location.

### SUMMARY

Multi-agent and human collaboration for project management involves the integration of software agents alongside human participants to improve project workflows and outcomes. Collaboration applications can leverage the power of artificial intelligence (AI) to facilitate collaboration between multiple software agents and humans. Interacting with a Large Language Model (LLM) in a multi-agent and human collaboration context for project management can involve orchestrating communication between the LLM, human team members, and the multiple software agents. However, leveraging LLMs to enhance multi-agent and human collaboration in project management comes with technical challenges. For example, coordinating between multiple AI agents and ensuring they work harmoniously with human team members is complex. Further, maintaining context over multiple interactions is challenging, especially in long-running projects with numerous tasks and updates.

Methods and systems for facilitating multi-agent and human project management and collaboration are provided. A multi-agent and human project management and collaboration tool (“collaboration tool”) can provide the ability to create and manage intelligent projects and intelligent agents in a cohesive framework. These intelligent projects are capable of organizing and documenting interactions between AI agents and human team members. The described collaboration tool can provide a multi-agent, multi-player channel where agents and humans work together to achieve an outcome. Custom AI agents can be dynamically generated based on a project's objective, allowing the system to be flexible on the types of projects/problems it can tackle. Each AI agent is equipped with a personalized skillset and memory, allowing the AI agents to effectively collaborate with human team members and each other to progress autonomously. The AI agents' interactions with the LLM and their task tracking capabilities (memory maintenance infrastructure) enable them to autonomously progress the project through various stages. Furthermore, although the system can operate autonomously through stages, multiple humans can interact with the system at any of several points during the various stages, allowing for collaboration between each other and the AI agents.

The collaboration tool can initialize a project structure comprising a project objective structure, a project status structure, a project plan structure, and a task log data resource structure. The task log data resource structure includes indicators of project completed tasks. The project completed tasks comprise tasks completed by agent objects. Each of the agent objects comprises a role field indicating a team member role, a skillset field indicating a distinct skillset based on that team member role, and an agent-specific task tracking data resource structure maintaining indicators of agent-specific completed tasks. The agent-specific completed tasks can include tasks completed by that agent object.

The collaboration tool can update the project structure in one or more stages. For a current stage of the one or more stages, the collaboration tool can retrieve a current version of the project plan structure for the current stage and perform operations to complete tasks assigned to the agent objects, respectively, from the current version of the project plan structure. For the current stage, the collaboration tool can also update the task log data resource structure using the agent-specific task tracking data resource structures for the agent objects, respectively, thereby producing an updated version of the task log data resource structure; update the project status structure using the updated version of the task log data resource structure, thereby producing an updated version of the project status structure; and update the project plan structure using the updated version of the task log data resource structure and the updated version of the project status structure, thereby producing an updated version of the project plan structure.

The collaboration tool can perform the operations to complete tasks by reading indicators of agent-specific completed tasks from the agent-specific task tracking data resource structure of the given agent object; generating a task prompt based at least in part on the team member role of the given agent object, the distinct skillset of the given agent object, the indicators of the agent-specific completed tasks of the given agent object, and the task assigned to the given agent object from the current version of the project plan structure; communicating the task prompt to an LLM and receiving a task result, as a completion of the task, from the LLM; and storing the task result in the agent-specific task tracking data resource structure as an indicator of an agent-specific completed task.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram that illustrates an example operating environment in which various embodiments of the invention may be practiced.

FIG. 2 is a class diagram that illustrates an example Unified Modeling Language (UML) diagram for an orchestration class.

FIG. 3 is a class diagram that illustrates an example UML diagram for an agent class.

FIG. 4 is a class diagram that illustrates an example UML diagram for a project class.

FIG. 5 is a diagram that illustrates interactions between instances of classes according to certain embodiments.

FIGS. 6A-6E illustrate example process flow diagrams implementing multi-agent and human project management and collaboration according to certain embodiments.

FIG. 7 is a diagram that illustrates an example computing system in which some described embodiments can be implemented.

FIG. 8 is a diagram that illustrates an example cloud-support environment that can be used in conjunction with the technologies described herein.

### DETAILED DESCRIPTION

Methods and systems for facilitating multi-agent and human project management and collaboration are provided. A multi-agent and human project management and collaboration tool (“collaboration tool”) can provide the ability to create and manage intelligent projects and intelligent agents in a cohesive framework. These intelligent projects can be used for organizing and documenting interactions between AI agents and human team members. The described collaboration tool can provide a multi-agent, multi-player channel where agents and humans work together to achieve an outcome. Custom AI agents can be created based on a project's objectives. Each agent is equipped with a personalized skillset and memory, allowing them to effectively collaborate with human team members and each other to progress autonomously. The agents' interactions with the LLM and their task tracking capabilities (memory maintenance infrastructure) enable them to autonomously progress the project through various stages.

The system for facilitating multi-agent and human project management and collaboration can be implemented with instances of software objects in two main classes, an agent class and a project class. The agent class represents an agent in the system. In some example implementations, each agent has a role, a job, and a list of completed tasks. The agent class includes methods for describing the agent, calling the LLM model, completing tasks, tracking tasks, and answering questions.

The project class represents a project in the system. In some example implementations, each project has a goal, a team, a name, a status, a plan, a summary, and a task log data resource. The project class includes methods for creating and updating a project report, tracking project stages, getting project details, doing tasks, and updating the project status and plan.

The described multi-agent and human project management and collaboration can start with the initiation of a new project. The project's goal is defined, and a team is built to achieve this goal. The team roles are parsed, and an agent is created for each role. The agents then start completing tasks based on the project plan and the results are stored in the agent's task tracking data resource (the agent's working memory). The project status is updated after each task completion. A report can be generated after each stage, providing a record of the project's progress. The system can also handle user inputs to suggest a different next step, update the objective, or ask a question to a team member.

Challenges arise within AI technology when trying to deploy machine learning models, particularly LLMs, for goal-oriented use cases. Some current AI-based language models use single-threaded interactions and require human input at each turn to refine the output.

LLMs can require human input at each turn to refine the output for several reasons. For example, human input can be used for clarification and context. Here, users provide context, ask questions, or clarify details for the LLM to refine responses based on the input to ensure relevance and accuracy. As an example, if a user asks about “frame rate,” the LLM needs to understand whether the context is video production, video games, or something else.

As another example, human input can be used to correcting misunderstandings made by the LLM. Here, with the human input, the LLM learns from these corrections to improve future responses. As an example, if the LLM incorrectly explains a technical term, the user can correct it, prompting the LLM to refine its explanation.

As yet another example, human input can be used to provide specific information to the LLM. Here, users provide specific details or constraints that guide the LLM's response, and the LLM tailors its response to meet these specific needs. As an example, a user might specify that they need an explanation suitable for a non-technical audience, leading the AI to simplify its language and avoid jargon.

Additionally, single-threaded interactions with LLMs present challenges in context management and efficiency, particularly in high-demand environments. Single-threaded interactions refer to a sequential and linear exchange of messages between a user and an LLM. Here, each interaction consists of one query and one response at a time, without parallel processing or simultaneous multi-query handling.

As one example of a challenge in context management and efficiency, the LLM may need to maintain context across multiple sequential turns, which can be challenging if the conversation is long or if context is complex. With single-threaded interactions there is only one memory or one context. Thus, every time a user interacts with the LLM, it is essentially like the user is starting fresh, as the LLM does not carry over context or memory from one interaction to the next.

The described collaboration tool can provide computational efficiency for objective-oriented use cases. The described collaboration enables the design and creation a set of specialized agents for a project objective. Experts (these specialized agents) work together in an iterative fashion to come up with the solution. That is, the system can continually and automatically iterate through stages of a project until either the system determines it has reached a resolution or the human user does. For the special agents to work together, state needs to be created and maintained for each agent, thus allowing them to go through each turn of the process and not have to start fresh. State is created through state maintenance, also called memory maintenance infrastructure herein, so each agent does not lose track of its state during the course of the project. This allows for a separation of concerns across multiple different agents that then work together in concert.

Approaches described herein provide technical solutions to technical problems in the deployment of machine learning models, particularly LLMs, for goal-oriented use cases. The technical solutions use a multi-agent, multi-player channel where agent objects (also called software agents, AI agents, bots, or simply agents) and humans work together to achieve an outcome. The approaches improve the process of problem solving and project management using LLMs by creating multiple agents with distinct skills and working memory that work together to complete tasks in an agentic manner and evaluate the output of each task against the initial goal.

Thus, the approaches described herein provide several technical advantages.

For example, unlike in conventional deployments of LLMs for goal-oriented use cases, described approaches can create multiple agents that, using memory maintenance infrastructure to work together to evaluate each output against the initial goal. To retain and update state, each agent can keep track of its own progress using a task tracking structure. In particular, each agent writes to an agent-specific task tracking data resource structure at the completion of a stage. Then, each agent can read the agent-specific task tracking data resource structure during the next stage to understand what the agent did in the last stage. This information is used for the next iteration. The agent-specific task tracking data resource structure helps each agent object understand its own state and its progress.

Advantageously, since each agent has a working memory, the human user does not have to maintain state as an individual. This can lead to a more computationally efficient process because the human user does not need to run multiple LLM calls or many iterations.

Furthermore, by creating a working memory for each agent, the chain of thought, reasoning, and planning of the agent per stage of the project can be tracked. This provides numerous advantages. These advantages can include, for example, allowing for better state maintenance and context, which facilitates use of the LLM for a long-running process, and providing transparency into the system and underlying processes that would otherwise be a black box.

As another example, unlike in conventional deployments of LLMs for goal-oriented use cases, described approaches allow for the use of LLMs to meet a given objective in a generic fashion. Typically, it takes trial and error with LLM prompts to get a desired outcome. That is, through efficient prompt engineering, a final prompt can be designed to be computationally efficient. Advantageously, with approaches described herein, the user does not need to have a multi-turn conversation with the LLM to get the desired outcome. Instead, the user can provide the system with an objective and the system can enable seamless collaboration between humans and AI agents, as well as the ability for the system to automatically progress towards its objectives.

In addition, the multi-agent construct allows the system to be self-reflective, or self-improving, without human intervention. For example, the system can include a ‘project plan’ function, which can evaluate the progress made on a project and can evaluate and correct the system based on logged outputs.

As used herein, the term “structure” refers to memory configured to store data in a computer system. The “structure” can be a field or attribute, multiple fields or attributes, or a pointer to a separate file.

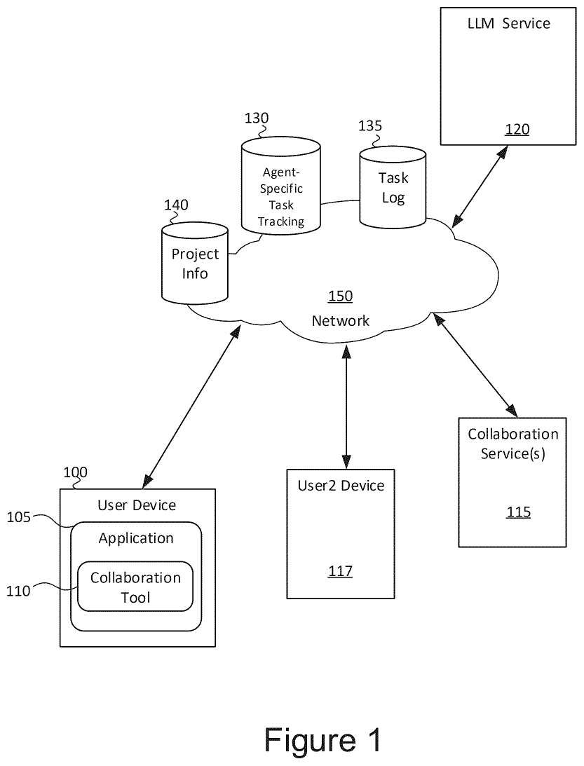

FIG. 1 illustrates an example operating environment in which various embodiments of the invention may be practiced. Referring to FIG. 1, the example operating environment may include one or more user computing devices 100 (e.g., user device 100 running an application 105 having a collaboration tool 110 and user 2 device 117), one or more services (e.g., collaboration service(s) 115 and LLM service 120), one or more data resources (e.g., agent-specific task tracking data resource structure 130, task log data resource structure 135, and project information data resource structure 140) and a network 150.

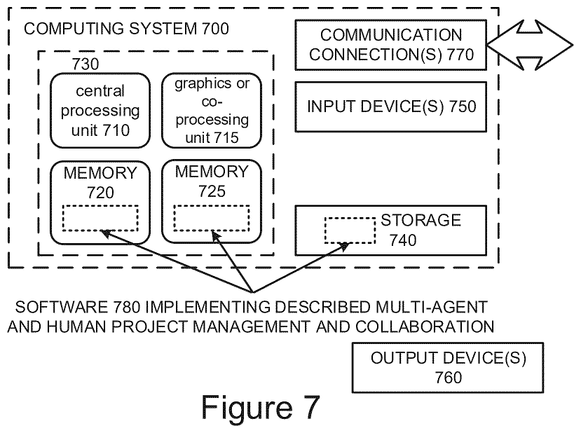

The user device 100 may be embodied as described with respect to system 700 in FIG. 7. The user device 100 can be, but is not limited to, a personal computer (e.g. desktop computer), laptop, personal digital assistant (PDA), video game device, mobile phone (or smart phone), tablet, slate, terminal, and the like. It should be apparent that the user device 100 maybe any type of computer system that provides its user the ability to load and execute software programs and the ability to access a network, such as network 150.

User 2 device 117 may include the same types of devices (or systems) as user device 100 and may or may not be of a same form.

A computing device (e.g., the user device 100) is configured to receive input from a user (not shown) through, for example, a keyboard, mouse, trackpad, touch pad, touch screen, microphone, or other input device. The display (not shown) of the user device 100 is configured to display one or more user interfaces (UI) to the user (not shown).

A UI enables a user to interact with various applications, such as application 105 having the collaboration tool, running on or displayed through the user device 100. Generally, a UI is configured such that a user may easily interact with functionality of an application. For example, a user may simply select (via, for example, touch, clicking, gesture or voice) an option within a UI to perform an operation such as sending a message in an application.

In some cases, the user device 100 may communicate with one or more other user computing devices (e.g., user 2 device 117).

Components (computing systems, data resource structures, and the like) in the operating environment may operate on or in communication with each other over the network 150. The network 150 can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network 150 may include one or more connected networks (e.g., a multi-network environment) including public networks, such as the Internet, and/or private networks such as a secure enterprise private network. Access to the network 150 may be provided via one or more wired or wireless access networks as will be understood by those skilled in the art.

As will also be appreciated by those skilled in the art, communication networks can take several different forms and can use several different communication protocols. Certain embodiments of the invention can be practiced in distributed-computing environments where tasks are performed by remote-processing devices that are linked through a communications network. In a distributed-computing environment, program modules can be located in both local and remote computer-readable storage media.

Communication to and from the system may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

The application 105 can be any suitable application, such as a collaboration application. As previously described, collaboration software encompasses a wide range of solutions that enable users to work together on documents, to exchange information, and in interact many other ways. A wide variety of software tools and services may be considered collaboration software, such as productivity applications, email, and chat services.

The application 105 can be stored on the user device 100 (e.g., a client-side application). In another embodiment, a user may access a web-based application (e.g., running on a server or hosted on a cloud) using a web browser (e.g., a standard internet browser), and the application's interface may be displayed to the user within the web browser. Thus, the application 105 may be a client-side application and/or a non-client side (e.g., a web-based) application.

The LLM service 120 can be a generative AI service and include an LLM. An LLM is a type of generative AI that can understand and generate human-like text, while multi-model generative AI extends this capability to generate a variety of media types, including text, images, audio, video, etc., allowing for more diverse and versatile content creation. In generative AI, such as LLMs, a prompt serves as an input or instruction that informs the AI of the desired content, context, or task, allowing users to guide the AI's text generation to produce tailored responses, explanations, or creative content based on the provided prompt.

In any of the examples herein, an LLM can take the form of an AI model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI, Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources. An LLM can be part of a multi-model generative AI service.

The agent-specific task tracking data resource structure 130 can maintain indicators of agent-specific completed tasks. The agent-specific completed tasks comprise tasks completed by an agent object. Each agent object includes or communicates with an agent-specific task tracking data resource structure. As will be discussed in more detail, the agent-specific task tracking data resource structure provides a working memory for each agent object. That is, each agent object can keep track of its own progress through the agent-specific task tracking data resource structure, which allows the agent object to maintain and update its state.

The task log data resource structure 135 can include indicators of project completed tasks. The project completed tasks maintains a task log of tasks completed by agent objects.

The project information data resource structure 140 can maintain information relating to a project, such as a project status structure indicating a project status, a project plan structure indicating a project plan, project report files, or current stage of the project.

It should be understood that these data resource structures may be a same or different resource structure.

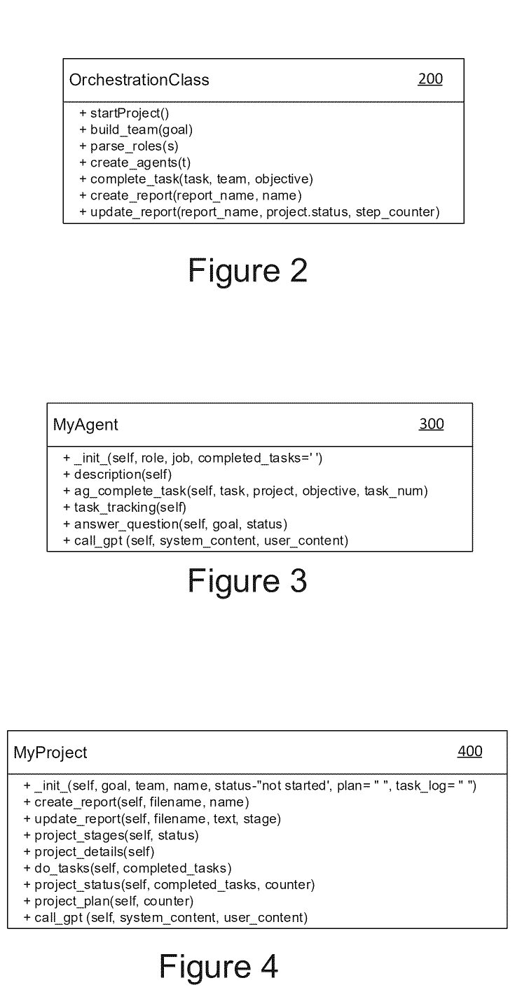

FIG. 2 illustrates an example Unified Modeling Language (UML) class diagram for an orchestration class in an example implementation. Referring to FIG. 2, the orchestration class allows for the integration of the collaboration tool with a collaboration system and facilitates ongoing, long-running interaction between agents and humans. It should be understood that, for a new project, there can be multiple humans interacting with multiple agents in a collaboration context. For the new project, an instance of the orchestration class can control project initialization, team building, role parsing, agent creation, task completion, project progression, report generation, and project completion.

In the illustrative example of FIG. 2, a UML class diagram 200 for the orchestration class can include a project initialization function (e.g., startproject( ) function), a team building function (e.g., build_team(goal) function), a role parsing function (e.g., parse_roles(s) function), an agent creation function (e.g., create_agents(t) function), a task completion function (e.g., complete_task(task, team, objective) function), and report generation functions (e.g., create_report(report_name, name) function and update_report(report_name, project.status, step_counter) function). Alternatively, the orchestration class can include other and/or additional functions.

The project initialization function (e.g., startproject ( ) function), when called, initiates a new project. Here, the startproject ( ) function can ask for the project's objective and name, and sets the step counter to 1.

An example of a portion of code for the project initialization function is shown in Table 1.

TABLE 1

```
def startproject( ):
  newproject=True
  while newproject:
    objective = input (“What is the objective? ”)
    project.goal=objective
    name=input (“What is the project name? ”)
    step_counter=1
    project.name=name
    team = build_team(objective)
    project.team, roles_only=parse_roles(team)
    myteam = create_agents(project.team)
    task = project.project_kickoff( )
    # print(task)
    print(“Team is completing the tasks”)
```

The team building function (e.g., build_team(goal) function) is called with the project's goal as an argument. Here, the build_team(goal) function can use the LLM model to identify the team members needed to achieve the goal. The team building function returns the team members as a string. Each team member has a specific team member role and a distinct skillset based on that team member's role.

Example code for the team building function is shown in Table 2.

```
TABLE 2
def build_team(goal):
  system_content = f“You are a team leader your task is to
identify the team members needed to achieve a goal. The team must
not be more than 5. List each role with the Role Name: Role
Description. Do not add a project manager role. Be concise.”
  user_content=f“The goal is {goal}”
  team = call_gpt(system_content, user_content)
  return team
```

The role parsing function (e.g., parse_roles(s) function), when called, takes the team string as input and parses the team string into a dictionary of roles and descriptions, and a list of roles only.

Example code for the role parsing function is shown in Table 3.

TABLE 3

```
def parse_roles(s):
  roles = { }
  roles_only =[ ]
  lines = s.split(‘\n’)
  for line in lines:
    if line.strip( ) != ‘’:
      role, description = line.split(‘:’)
      # Remove a number and a period at the beginning of
the role name
      role = re.sub(r‘\hat{ }\d+\.’, ‘’,
role).strip( ).replace(‘/’,‘’)
      roles[role] = description.strip( )
    roles_only.append(role)
  return roles, roles_only
```

The agent creation function (e.g., create_agents(t) function), when called, can iterate over the team members and create an agent for each role on the team using the agent class. The agent class will be described in detail with reference to FIG. 3.

Example code for the agent creation function is shown in Table 4.

TABLE 4

```
def create_agents(t):
  #iterate over the team and create agents for each role on the team
  agents={ }
  print(t)
  for k,v in t.items( ):
    k=to_snake_case(k)
    agent_object=k+“_agent”
    agent_object= MyAgent(k,v)
    agents[k]=agent_object
  return agents
```

The task completion function (e.g., complete_task(task, team, objective) function), when called, is used to complete the tasks. Through the complete_task (task, team, objective) function, each agent can complete its task, and the results are stored in the agent-specific task tracking data resource structure associated with that agent.

Example code for the task completion function is shown in Table 5.

TABLE 5

```
def complete_task(task, team, objective):
  task_completion={ }
  for k,v in team.items( ):
    task_completion[k]=team[k].ag_complete_task(task, name,
objective, step_counter)
  if debug:
    print (“Task Completion ”, task_completion)
  return task_completion
```

FIG. 3 illustrates an example UML class diagram for an agent class in an example implementation. Referring to FIG. 3, an instance of the agent class represents an agent in the system that implements the collaboration tool. In the overall system architecture, multiple instances of the agent class are created, each representing a different role in the project team. These agents work together to complete tasks and achieve the project's objective. Advantageously, each agents' interactions with the LLM and their task tracking capabilities enable them to autonomously progress the project through various stages.

Each instance of the agent class can encapsulate the details and operations related to a specific agent. Each agent has a role, a job, and a list of completed tasks. Each instance of the agent class is used to manage all aspects of the agent, including describing the agent, calling the LLM model, completing tasks, tracking tasks, and answering questions.

In the illustrative example of FIG. 3, a UML class diagram 300 for the agent class (“MyAgent”) can include an initialization method (e.g., _init_(self, role, job, completed_tasks=‘ ’)), a description method (e.g., description (self)), a task completion method (e.g., ag_complete_task(self, task, project, objective, task_num)), a task tracking method (e.g., task_tracking(self)), a question answering method (e.g., answer_question(self, goal, status)), and an LLM call method (e.g., call_gpt(self, system_content, user_content)). Alternatively, the agent class can include other and/or additional functions.

The initialization method (e.g., _init_(self, role, job, completed_tasks=‘ ’)), when called, can initialize an agent with a role, job, and completed tasks. The initialization method can also set up an agent-specific task tracking data resource structure. The role determines the specific agent's skillset based on the project goals. Each agent has a distinct role and job on the project team.

Example code for the initialization method is shown in Table 6.

TABLE 6

```
def _{——}init_{——}(self, role, job, completed_tasks=‘’):
  self.role = role
  self.job= job
  self.completed_tasks=completed_tasks
  global task_tracker
  task_tracker=“”
  self.debug = False
```

The description method (e.g., description (self)), when called, can print a description of the agent object's role and job.

Example code for the description method is shown in Table 7.

TABLE 7

def description(self):
print(f“I am a {self.role} and I {self.job}”)

The task completion method (e.g., ag_complete_task (self, task, project, objective, task_num)), when called, can be used by an agent object to complete a task based on that agent object's specific skills and role on the team. The task completion method can use the LLM call method to generate a response based on the task, project, objective, and task number. The completed task can then be written to the agent's agent-specific task tracking data resource structure. The agent-specific task tracking data resource structure acts as the agent's working memory for the project.

Example code for the task completion method is shown in Table 8.

```
TABLE 8
def ag_complete_task(self, task, project, objective, task_num):
  # task_num=1
  if self.debug:
    print(f“{self.role} task tracker activated”)
  if task_num > 1:
    completed_tasks = self.task_tracking( )
    p = f“You must complete this {task} as a next step to your
previous tasks listed here {completed_tasks}. Describe the steps to
complete the tas and the outcome. Your response should be in bullet
points and be action focused. Be concise.”
  else:
    p = f“You must complete this {task}. Describe the steps to
complete the task and the outcome. Your response should be in bullet
points and be action focused. Be concise.”
    s=f“You are a {self.role}. Your job is {self.job} and your
objective is {objective}. Based on the status of the project identify
the next step that you need to take and the outcome. Always be
concise.”
  completed_task =self.call_gpt(s,p)
  task_num_str=str(task_num)
  self.task_tracker=self.role+“_”+project+“_task_tracker.txt”
  with open(self.task_tracker, ‘a’) as f:
    f.write(“Task Number ” + task_num_str + “: ”+
completed_task+‘/n’)
  # task_num+=1
  return completed_task
```

The task tracking method (e.g., task_tracking (self)), when called, can be used to read the completed tasks from the agent-specific task tracking data resource structure. The task tracking method can return indicators of completed tasks (completed_tasks).

Example code for the task tracking method is shown in Table 9.

TABLE 9

```
def task_tracking(self):
  f = open(self.task_tracker,‘r’)
  completed_tasks=f.read( )
  f.close( )
  if self.debug:
    print(f“{self.role} : {completed_tasks}”)
  return completed_tasks
```

The question answering method (e.g., answer_question (self, goal, status)), when called, can be used to answer a question based on the goal, status, and completed tasks. The question answering method can use the LLM call method to generate an answer.

Example code for the question answering method is shown in Table 10.

```
TABLE 10
def answer_question(self, goal, status):
  question = input(“What is your question? ”)
  s=f“You are a {self.role}. Your job is {self.job} working on
{goal}. The overall status of the project is {status} ”
  completed_tasks = self.task_tracking( )
  p = f“The project stakeholder is asking you this question
{question}. Answer it based on your {completed_tasks}. Be concise.”
  answer = self.call_gpt(s,p)
  return answer
```

The LLM call method (e.g., call gpt (self, system_content, user_content)), when called, can be used to interact with the LLM model. The LLM call method can take system content and/or user content as inputs and return the LLM model's response.

Example code for the LLM call method is shown in Table 11.

TABLE 11

```
def call_gpt(self, system_content, user_content):
  response = openai.ChatCompletion.create(
        model=“gpt-3.5-turbo-16k”,
        messages=[
          {
            “role”:“system”,
            “content”:system_content
          },
          {
            “role”:“user”,
            “content”:user_content
          }
        ],
        temperature=0.8,
        max_tokens=500,
        top_p=1,
        frequency_penalty=0,
        presence_penalty=0
      )
    # if response.ok:
  content = response[“choices”][0][“message”][‘content’]
  return content
```

FIG. 4 illustrates an example UML class diagram for a project class in an example implementation. Referring to FIG. 4, an instance of the project class represents a project in the system that implements the collaboration tool. Each project has a goal, a team, a name, a status, a plan, a summary, and a task log data resource structure. In the overall system architecture, an instance of the project class is created for each project. Each instance of the project class can encapsulate the details and operations related to a specific project. Indeed, each instance is used to manage all aspects of the project, including creating and updating reports, tracking project stages, executing tasks, and updating the project status and plan.

In the illustrative example of FIG. 4, a UML class diagram 400 for the project class (“MyProject”) can include an initialization method (e.g., init_(self, goal, team, name, status—“not started”, plan=“ ”, task_log=“ ”)), a report creation method (e.g., create_report (self, filename, name)), an report update method (e.g., update_report(self, filename, text, stage)), a project stages method (e.g., project_stages(self, status)), a project details method (e.g., project_details(self)), a task execution method (e.g., do_tasks(self, completed_tasks)), a project status method (e.g., project_status(self, completed_tasks, counter)), a project plan method (e.g., project_plan(self, counter)), and an LLM call method (e.g., call_gpt(self, system_content, user_content)). Alternatively, the project class can include other and/or additional functions.

The initialization method (e.g., _init_(self, goal, team, name, status—“not started’, plan=“ ”, task_log=“ ”)), when called, can initialize a project with a goal, team, name, status, plan, summary, and task log data resource structure.

Example code for the initialization method is shown in Table 12.

```
TABLE 12
def _{——}init_{——}(self, goal, team, name, status=“not started”, plan=“”,
summary=“”, task_log=“”):
  self.goal = goal
  self.team= team
  self.name=name
  self.status=status
  self.plan=plan
  self.summary=summary
  self.debug = False
  self.task_log = task_log
```

The report creation method (e.g., create_report(self, filename, name)), when called, can create a report file for the project. The report creation method can write the project name, goal, team, and plan to a file. The report can be used to keep track of all the stages of the project.

Example code for the report creation method is shown in Table 13.

TABLE 13

```
def create_report(self, filename, name):
  str_team = json.dumps(self.team)
  with open(filename, ‘w’) as f:
    print(“creating report”)
    f.write(“Project name: ”+name+‘\n’+“Project Goal: ” +
self.goal + ‘\n’ + ‘\n’ + “Project Team: ” + str_team+‘\n’+‘\n’+
“Project Plan: ” + self.plan +‘\n’+‘\n’)
```

The report update method (e.g., update_report(self, filename, text, stage)), when called, can update the project report with new text for a given stage.

Example code for the report update method is shown in Table 14.

TABLE 14

```
def update_report(self, filename, text, stage):
  print(“updating report”)
  if stage == 0:
    stage = “end”
  else:
    stage=str(stage)
    text = str(text)
  with open (filename, ‘a’) as f:
    f.write(‘\n’+ “Stage ”+ stage+“: ”+ text + ‘\n’)
```

The project stages method (e.g., project_stages(self, status)), when called, can keep track of the project stages and records of events.

Example code for project stages method is shown in Table 15.

TABLE 15

```
def project_stages(self, status):
  stage_num= 1
  record_of_events=‘’
  step = str(stage_num)
  record_of_events += “Stage: ” + step + status
  stage_num+=1
  return record_of_events
```

The project details method (e.g., project_details(self)), when called, can read the project details from a file.

Example code for the project details method is shown in Table 16.

TABLE 16

```
def project_details(self):
  f = open(self.name+“.txt”)
  project_details = f.read( )
  f.close( )
  return project_details
```

The task execution method (e.g., do_tasks(self, completed_tasks)), when called, can extract the completed tasks from an agent-specific task tracking data resource structure and store them in the task log data resource structure.

Example code for the task execution method is shown in Table 17.

TABLE 17

```
def do_tasks(self,completed_tasks):
  task_list=[ ]
  for k,v in completed_tasks.items( ):
    task_list.append(v)
  self.task_log=task_list
  return task_list
```

The project status method (e.g., project_status(self, completed_tasks, counter)), when called, can update the project status based on the completed tasks and the current counter. The project status method can use the LLM call method to generate a project strategy or a summary of the project status.

Example code for the project status method is shown in Table 18.

```
TABLE 18
def project_status(self,completed_tasks, counter):
  #extract the tasks completed from the dictionary
  # tasks=[ ]
  # for k,v in completed_tasks.items( ):
  # tasks.append(v)
  tasks= self.do_tasks(completed_tasks)
  if counter <=1:
    project_details = self.project_details( )
    s=f“You are a project manager working on {self.goal} with
a team of {self.team}. Your job is to manage the project to ensure it
meets the goal.”
    p=f“The team has just kicked off the project with this
plan {self.plan} and completed these tasks {tasks}. Write a very short
summary of the project status based on the project details
{project_details}. Be concise.”
  else:
    s=f“You are a project manager working on {self.goal} with
a team of {self.team}. Your job is to manage the project to ensure it
meets the goal.”
    p=f“The team has just completed these tasks {tasks} based
on this plan {self.plan}. Write a very short project strategy for your
stakeholders. Focus on outcomes. You must document the outcomes
towards the specific progress towards the goal. Be concise.”
  project_status = call_gpt(s,p)
  #update the status of the project
  if self.debug:
    print(f“Old Status: {self.status}”)
  self.status=project_status
  if self.debug:
    print(f“New Status: {self.status}”)
  return project_status
```

The project plan method (e.g., project_plan(self, counter)), when called, can update the project plan based on the current status of the project, the completed tasks, and the current counter. The project plan method can use the LLM call method to generate a next step in the project strategy.

Example code for the project plan method is shown in Table 19.

```
TABLE 19
def project_plan(self,counter):
  if self.debug:
    print(“Task Log in project_plan: ”, self.task_log)
  s=f“You are a project manager working on {self.goal} with a
team of {self.team}. Your job is to determine the status of the
project and what needs to happen next based the current status.”
  p=f“This is the current status of the project: {self.status}
and the completed tasks {self.task_log}. Determine the next step. You
must always make meaningful progress against the goal. If the project
has met the objective respond with <end>projectcompleted</end>. Be
concise.”
  plan = call_gpt(s,p)
  self.plan = plan
  # self.update_report(self.name+“.txt”, “Project phase plan: ”
+ plan, counter,)
  return plan
```

As previously described, the LLM call method (e.g., call_gpt (self, system_content, user_content)), when called, can be used to interact with the LLM model. The LLM call method can take system content and/or user content as inputs and return the LLM model's response.

Example code for the LLM call method is shown in Table 20.

TABLE 20

```
def call_gpt(self, system_content, user_content):
  response = openai.ChatCompletion.create(
        model=“gpt-3.5-turbo-16k”,
        messages=[
          {
            “role”:“system”,
            “content”:system_content
          },
          {
            “role”:“user”,
            “content”:user_content
          }
        ],
        temperature=0.8,
        max_tokens=250,
        top_p=1,
        frequency_penalty=0,
        presence_penalty=0
      )
    # if response.ok:
  content = response[“choices”][0][“message”][‘content’]
  return content
```

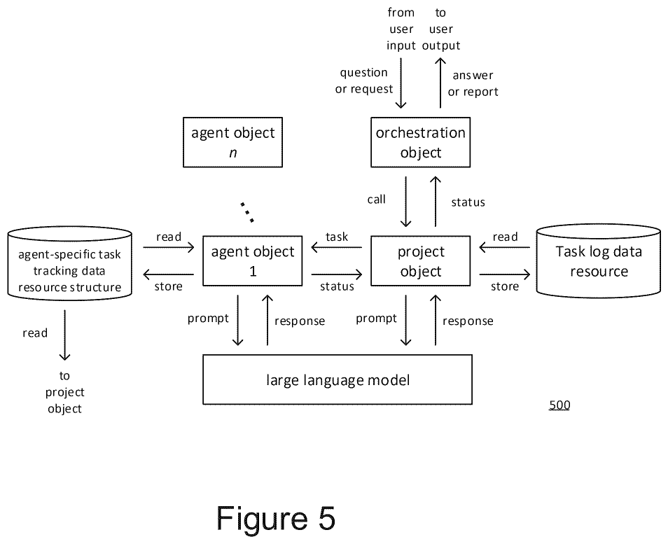

FIG. 5 illustrates, in an example software architecture (500), interactions between instances of classes, interactions between the instances of classes and an LLM, and interactions between instances of classes and data resources. In FIG. 5, the software architecture (500) includes multiple agent objects (labeled agent object 1 to agent object n), which are instances of an agent class. The software architecture (500) also includes a project object, which an instance of a project class, and an orchestration object, which is an instance of an orchestration class.

The orchestration object allows for the integration of the collaboration tool with a collaboration system and facilitates ongoing, long-running interaction between agent objects and humans. The orchestration object is configured to receive a question or request from user input from one or more users and provide an answer or report to the one or more users as user output. For example, a request can relate to setting, adjusting, or reporting the project objective for a project. The orchestration object is further configured to communicate via one or more calls to the project object, for example, to call a function of the project object to initialize the project object with a team. The project object is configured to provide status updates to the orchestration object. In addition, the orchestration object is configured to interact (not shown) with the LLM, providing prompts to the LLM and receiving responses from the LLM, as described with reference to FIG. 2.

The project object is configured to read indicators of project completed tasks from a task log data resource structure. The project object is further configured to read indicators of agent-specific completed tasks from an agent-specific task tracking data resource and store the indicators of agent-specific completed tasks in an updated version of the task log data resource structure as indicators of project completed tasks. In addition, the project object is configured to interact with the LLM, providing prompts to the LLM and receiving responses from the LLM, as described with reference to FIG. 4. The project object is further configured to provide a task to the agent object, for examples, in a call requesting that the agent object perform the task, and to receive a status update from the agent object. The project object can also be configured to receive a question or request from user input (not shown) and provide an answer or report to the user as user output (not shown). For example, a request can relate to explaining the status of the project or stages of the project.

An agent object (e.g., agent object 1 . . . agent object n) is configured to read the indicators of agent-specific completed tasks from the agent-specific task tracking data resource and store the indicators of agent-specific completed tasks in the agent-specific task tracking data resource. In addition, the agent object is configured to interact with the LLM, providing prompts to the LLM and receiving responses from the LLM, as described with reference to FIG. 3. The agent object is further configured to receive a question or request from user input (not shown) and provide an answer or report to the user as user output (not shown). For example, a request can relate to explaining the role of the agent object or how the agent object interacts with other agent objects.

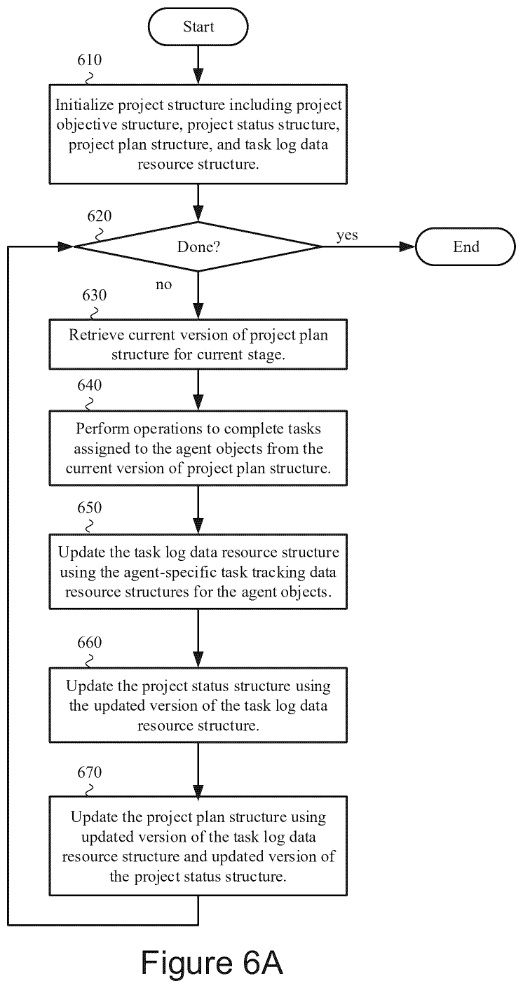

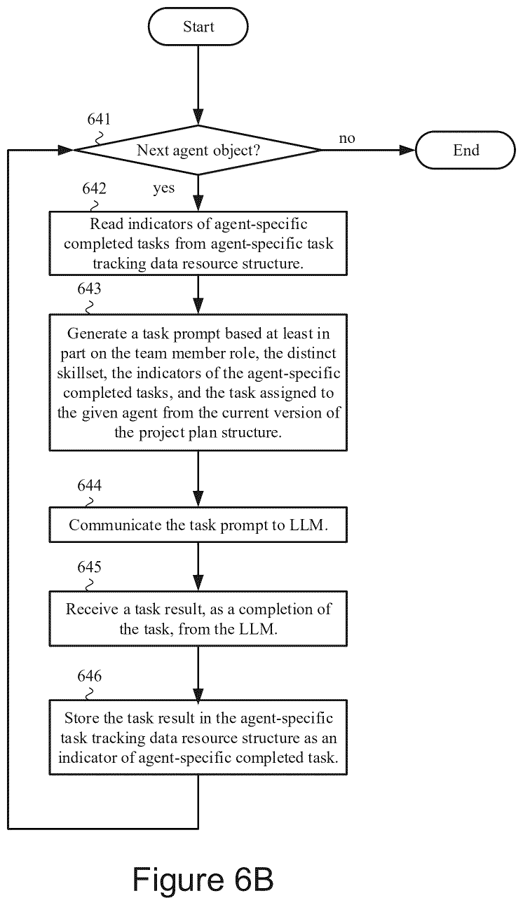

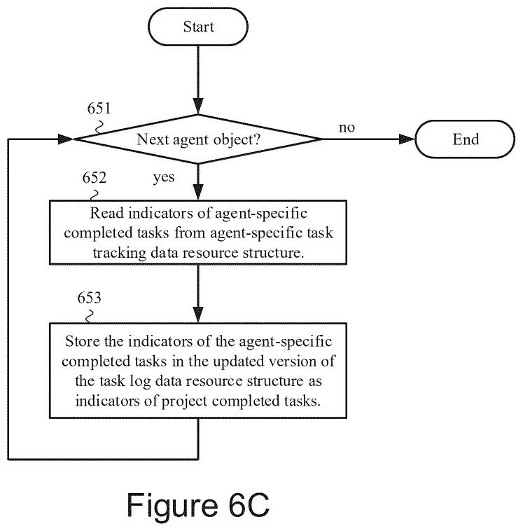

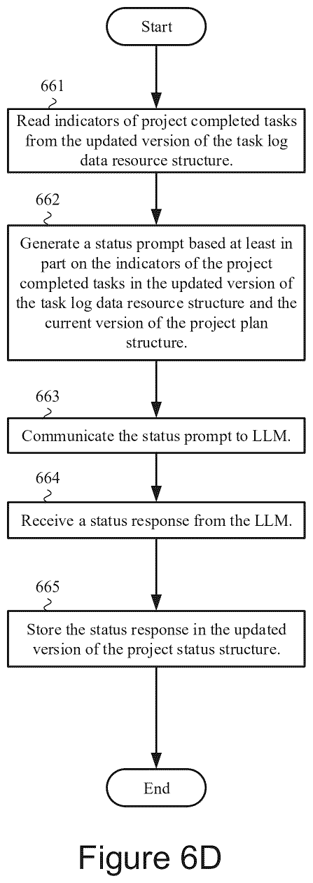

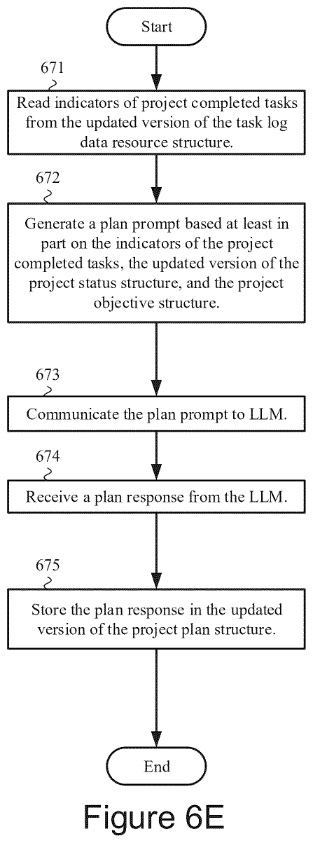

FIGS. 6A-6E illustrate example process flow diagrams implementing multi-agent and human project management and collaboration according to certain embodiments. A collaboration tool performing processes such as illustrated in FIGS. 6A-6E can be implemented by a computing system, which can be embodied as described with respect to computing system 700, as shown in FIG. 7.

Referring to FIG. 6A, the collaboration tool can initialize a project structure for a project comprising a project objective structure indicating a project objective, a project status structure indicating a project status, a project plan structure indicating a project plan, and a task log data resource structure, as described in flow 610. As previously described, the task log data resource structure can include indicators of project completed tasks, where the project completed tasks are tasks completed by agent objects.

During initialization, the collaboration tool can receive an indication of the project objective structure for the project structure. Here, a user may provide a project objective and project name when prompted by the system. The project objective and project name can be stored in a data resource structure (e.g., task log data resource structure 135 or project information data resource structure 140 described in FIG. 1) as the project objective structure and a project name structure, respectively.

The collaboration tool can generate a project team for the project. To generate the project team, the collaboration tool can identify team member roles needed to accomplish the project objective. The collaboration tool can generate a team prompt based at least in part on the project objective structure.

In any of the examples herein, prompts can be provided to LLMs to generate responses. Prompts in LLMs can be initial input instructions that guide model behavior. Prompts can be textual cues, questions, or statements provided to elicit desired responses from the LLMs. Prompts can act as primers for the model's generative process. Sources of prompts can include user-generated queries, predefined templates, or system-generated suggestions. Technically, prompts are tokenized and embedded into the model's input sequence, serving as conditioning signals for subsequent text generation. In particular, the structure, format, and tuning of prompts can enable a collaboration tool to manage a project effectively through stages. For example, the prompt in the described system includes two components, a system prompt and a user prompt. System prompts are supplied by the system, after training to fine-tune the structure and format of the system prompts. A user prompt is provided by a user and supplements a system prompt. The structure of a system prompt can be designed to optimize for the desired output of a function. The outputs generated by the system prompt can be evaluated for accuracy, relevance, and adherence to the system objective. This evaluation can be automated or manual, and it often involves comparing the system response to a set of expected results. Based on the evaluation, the system prompt can be iteratively refined to improve the system performance. This involves adjusting the language, structure, or context provided in the system prompt. The iterative process can continue until the system prompts consistently yield high-quality outputs that meet the user's needs and the system's objectives. The system prompts in the described system can be highly tuned for the specific objective of a multi-agent human goal-oriented collaboration, with expected supplementation by user prompts.

An example team prompt can include “You are a team leader your task is to identify the team members needed to achieve a goal. The team must not be more than 5. List each role with the Role Name: Role Description. Do not add a project manager role. Be concise” for the system content and “The objective is {objective}” for the user content. Here, the {objective} provides the context which is passed to the LLM.

The collaboration tool can communicate the team prompt to the LLM and receive the team member roles back from the LLM.

The collaboration tool can create an agent object for each team member role on the project team. Each of the agent objects can include a role field indicating a team member role, a skillset field indicating a distinct skillset based on that team member role, and an agent-specific task tracking data resource structure maintaining indicators of agent-specific completed tasks. The collaboration tool can store the indicators of the team member roles and associated role descriptions in role fields and skillset fields of corresponding ones of the agent objects.

In an illustrative example of a project (Project Nightleash) where the user inputs a project objective of “Design and develop a dog leash for walking the dog at night in the winter,” the collaboration tool can build a project team needed to achieve that project objective and create an agent for each role on the project team. Here, the collaboration tool creates five agents ‘Industrial Designer,’ ‘Material Scientist,’ ‘Electronics Engineer,’ ‘Mechanical Engineer,’ and ‘Product Tester.’ The descriptions for each agent's role includes {‘Industrial Designer’: ‘Responsible for creating a functional and visually appealing design for the dog leash that is suitable for nighttime use in winter conditions.’; ‘Material Scientist’: ‘Responsible for selecting and testing materials that are durable, weather-resistant, and provide visibility in low light conditions.’, ‘Electronics Engineer’: Responsible for integrating LED lights or other illumination technology into the dog leash for enhanced visibility during nighttime walks.‘, Mechanical Engineer’: ‘Responsible for ensuring the dog leash is mechanically sound, comfortable to use, and can withstand the pulling force of a dog.’, “Product Tester”: ‘Responsible for testing the prototype dog leash in various winter conditions, ensuring it meets safety standards, is user-friendly, and performs as intended.’}.

The agent-specific task tracking data resource structure provides each agent object with memory maintenance infrastructure. Advantageously, this memory maintenance infrastructure, or working memory, maintains the state for each agent.

The collaboration tool can also create a project report file for the project structure. The project report file provides a record of progress for the project structure and can include the project objective structure, indicators of the project team, the current stage of the one or more stages, the current version of the project plan structure, and the project status structure. The project report file can be updated at the completion of each stage.

The collaboration tool can determine if the project has been completed, as shown at decision 620. In some cases, the collaboration tool can determine the project is completed if the collaboration tool determines an updated version of the project status structure indicates the project objective has been met. In some cases, the collaboration tool can determine the project is completed if a user ends the project.

If the collaboration tool determines the project is completed, the process flow for multi-agent and human project management and collaboration ends.

If the collaboration tool determines the project is not completed, the project can move on to the next stage. Here, the collaboration tool can update the project structure in one or more stages, including, for a current stage of the one or more stages. When updating the project structure, the collaboration tool can perform the processes described at flow 630, flow 640, flow 650, flow 660, and flow 670.

The collaboration tool can retrieve the current version of the project plan indicated in the project plan structure for the current stage, as described in flow 630. As previously described, the project objective can be stored in a data resource structure (e.g., task log data resource structure 135 or project information data resource structure 140 described in FIG. 1) as the project objective structure. The project plan can include information regarding what should happen in the next stage based the current status of the project, including, for example, tasks to be assigned to the agent objects.

Returning to the illustrative example of Project Nightleash, a project plan for one of the beginning stages of the project can include “The project team is in the initial stages of designing dog leash for nighttime use in winter conditions. The Industrial Designer is currently creating a design concept that meets the required features.”

FIG. 6B illustrates an example process flow diagram for performing operations to complete tasks assigned to the agent objects from the current version of the project plan structure, as described in flow 640 of FIG. 6A.

Referring to both FIG. 6A and FIG. 6B, while performing the operations to complete tasks assigned to the agent objects from the current version of the project plan structure, the collaboration tool can loop through each of the agent objects. For example, each agent object is assigned a task for each stage of the project based on the current version of the project plan structure. Then, to complete the current stage of the project, the collaboration tool can perform operations to complete each of those tasks assigned to the agent object.

Here, the collaboration tool can determine if there is a next agent object, as shown at decision 641. If the collaboration tool determines there is not a next agent object, flow 640 ends.

If the collaboration tool determines there is a next agent object, the collaboration tool can read indicators of agent-specific completed tasks from the agent-specific task tracking data resource structure of the given agent object, as described in flow 642. The indicators of agent-specific completed tasks can be a text description of the task, as well as the outcome of the completed task. As previously described, each agent object's agent-specific task tracking data resource structure provides the software object with a working memory and includes an indicator for each task completed by that agent object.

The collaboration tool can generate a task prompt, as described in flow 643. The task prompt can be based at least in part on the team member role of the given agent object, the distinct skillset of the given agent object, the indicators of the agent-specific completed tasks of the given agent object, and the task assigned to the given agent object from the current version of the project plan structure.

As an example, if the task assigned to the given agent object is the first task, the task prompt can include “You must complete this {task} as a next step to your previous tasks listed here {completed_tasks}. Describe the steps to complete the task and the outcome. Your response should be in bullet points and be action focused. Be concise.” As another example, if the task assigned to the given agent object is not the first task the task prompt can include “You must complete this {task}. Describe the steps to complete the task and the outcome. Your response should be in bullet points and be action focused. Be concise.” as the system content and “You are a {self.role}. Your job is {self.job} and your objective is {objective}. Based on the status of the project identify the next step that you need to take and the outcome. Always be concise.” as the user content. Here, the user is the given agent and {task}, {completed_tasks}, {self.role}, {self.job}, and {objective} contains the context passed to the LLM.

The collaboration tool can communicate the task prompt to an LLM, as described in flow 644, receive a task result, as a completion of the task, from the LLM, as described in flow 645. The collaboration tool can store the task result in the agent-specific task tracking data resource structure as an indicator of an agent-specific completed task, as described in flow 646.

Once the operations to complete tasks assigned to the given agent object have been performed, the process flow returns to decision 641 to determine if there is a next agent object. If the collaboration tool determines the given agent is the not the last agent, flow 642, flow 643, flow 644, flow 645, and flow 646 can be repeated for the next agent object. That is, as part of the current stage, for another agent object of the agent objects, the process of reading of the agent-specific completed tasks, generating of the task prompt, communicating of the task prompt, receiving of the task result, and storing of the task result are repeated for each agent object.

If the collaboration tool determines the given agent is the last agent, the process flow 640 for performing operations to complete tasks ends. At the completion of flow 640, each agent object will have completed the task assigned to that agent object for the current stage and an indicator of that completed task will be stored in that agent object's agent-specific task tracking data resource structure.

Returning to FIG. 6A, once the collaboration tool has performed the operations to complete tasks assigned to the agent objects from the current version of the project plan structure, as described in flow 640, the collaboration tool can update the task log data resource structure using the agent-specific task tracking data resource structure for the agent objects, as described in flow 650. Here, the collaboration tool can update the task log data resource structure to include each completed task completed in flow 640.

FIG. 6C illustrates an example process flow diagram for updating the task log data resource structure using the agent-specific task tracking data resource structures for the agent objects, as described in flow 650 of FIG. 6A.

Referring to both FIG. 6A and FIG. 6C, when updating the task log data resource structure, the collaboration tool can perform flow 652 and flow 653 for each agent object. Similar to flow 640, the collaboration tool can loop through each of the agent objects when updating the task log data resource structure. Here, the collaboration tool can determine if there is a next agent object, as shown at decision 651. When looping through the agent objects, if the collaboration tool determines there is not a next agent object, flow 650 ends.

If the collaboration tool determines there is a next agent object, the collaboration tool can read indicators of agent-specific completed tasks from the agent-specific task tracking data resource structure of the given agent object, as described in flow 652.

The collaboration tool can store the indicators of the agent-specific completed tasks in the updated version of the task log data resource structure as indicators of project completed tasks, as described in flow 653.

The task log data resource structure maintains a running list of all tasks completed throughout the project. At the completion of flow 650, the task log data resource structure will be updated to include each completed task completed in flow 640.

Returning to FIG. 6A, once the collaboration tool has updated the task log data resource structure using the agent-specific task tracking data resource structure for the agent objects, as described in flow 650, the collaboration tool can update the project status structure using that updated version of the task log data resource structure, as described in flow 660.

FIG. 6D illustrates an example process flow diagram for updating the project status structure using the updated version of the task log data resource structure, as described in flow 660 of FIG. 6A. The project status structure can be updated after each stage of the project. That is, the status can be updated once each task is completed for the current stage.

Referring to both FIG. 6A and FIG. 6D, when updating the project status structure, the collaboration tool can perform flow 661, flow 662, flow 663, flow 664, and flow 665.

The collaboration tool can read indicators of project completed tasks from the updated version of the task log data resource structure, as described in flow 661. Here, the collaboration tool can read the indicators for each task completed throughout the project.

The collaboration tool can generate a status prompt based at least in part on the indicators of the project completed tasks in the updated version of the task log data resource structure and the current version of the project plan structure, as described in flow 662.

As an example, if the current stage is the first stage, the status prompt can include “You are a project manager working on {self.goal} with a team of {self.team}. Your job is to manage the project to ensure it meets the goal.” as the system content and “The team has just kicked off the project with this plan {self.plan} and completed these tasks {tasks}. Write a very short summary of the project status based on the project details {project_details}. Be concise.” as the user content.

As another example, if the current stage is not the first stage, the status prompt can include “You are a project manager working on {self.goal} with a team of {self.team}. Your job is to manage the project to ensure it meets the goal.” as the system content and “The team has just completed these tasks {tasks} based on this plan {self.plan}. Write a very short project strategy for your stakeholders. Focus on outcomes. You must document the outcomes towards the specific progress towards the goal. Be concise.” as the user content.

Here, the user is the project structure and {self.goal}, {self.team}, {self.plan}, and {project_details} contains the context passed to the LLM.

The collaboration tool can communicate the status prompt to the LLM, as described in flow 663 and receive a status response from the LLM, as described in flow 664. The collaboration tool can store the status response in the updated version of the project status structure, as described in flow 665.

Returning to FIG. 6A, once the collaboration tool has updated project status structure, as described in flow 660, the collaboration tool can update the project plan structure using that updated version of the project status structure and the updated version of the task log data resource structure, as described in flow 670.

FIG. 6E illustrates an example process flow diagram for updating the project plan structure using the updated version of the task log data resource structure and the updated version of the project plan structure, as described in flow 670 of FIG. 6A. Referring to both FIG. 6A and FIG. 6E, when updating the project status structure, the collaboration tool can perform flow 671, flow 672, flow 673, flow 674, and flow 675.

The collaboration tool can read indicators of project completed tasks from the updated version of the task log data resource structure, as described in flow 671.

The collaboration tool can generate a plan prompt based at least in part on the indicators of the project completed tasks, the updated version of the project status structure, and the project objective structure, as described in flow 672.

As an example, the plan prompt can include “You are a project manager working on {self.goal} with a team of {self.team}. Your job is to determine the status of the project and what needs to happen next based the current status.” as the system content and “This is the current status of the project: {self.status} and the completed tasks {self.task_log}. Determine the next step. You must always make meaningful progress against the goal. If the project has met the objective respond with <end>projectcompleted</end>. Be concise.” as the user content.

Here, the user is the project structure and {self.goal}, {self.team}, {self.status}, and {self.task_log} contains the context passed to the LLM.

The collaboration tool can communicate the plan prompt to the LLM, as described in flow 673 and receive a plan response from the LLM, as described in flow 674. The collaboration tool can store the plan response in the updated version of the project plan structure, as described in flow 675.

Returning to the illustrative example of Project Nightleash, an updated project plan for a next step in the project can include “The next step in the project is for the Industrial Designer to finalize the design concept, along with specifications and technical drawings for the dog leash. This will lead to the outcome of having a complete and accurate design concept, along with specifications and technical drawings that will serve as a guide for manufacturing the dog leash.”

The collaboration tool can update the project report file for the project structure to include the updated version of the project status structure and the updated version of the project plan structure.

Returning to FIG. 6A, once the project plan structure has been updated, as described in flow 670, the current stage can be considered complete. The process flow for multi-agent and human project management and collaboration can then return to decision 620 to determine if the project has been completed.

As previously described, in some cases, the collaboration tool can determine the project is complete if the collaboration tool determines the updated version of the project status structure indicates the project object has been met. In some cases, the collaboration tool can determine the project is completed if a user ends the project.

If the collaboration tool determines the project is completed, the process flow for multi-agent and human project management and collaboration ends. The collaboration can generate a detailed summary report file indicating completion of the project structure. The detailed summary report file can include a summary of each of the one or more stages. The collaboration too can provide the detailed summary report file for display.

Returning to the illustrative example of Project Nightleash, an example detailed summary report is shown in Table 21.

TABLE 21
Project Name: Nightleash
Project Goal: Design and develop a dog leash for walking the dog at night in the winter
Project Team: {‘Industrial Designer’: ‘Responsible for creating a functional and visually
appealing design for the dog leash that is suitable for nighttime use in winter conditions.’,
‘Material Scientist’: ‘Responsible for selecting and testing materials that are durable,
weather-resistant, and provide visibility in low light conditions.’, ‘Electronics Engineer’:
Responsible for integrating LED lights or other illumination technology into the dog
leash for enhanced visibility during nighttime walks.’, Mechanical Engineer’:
‘Responsible for ensuring the dog leash is mechanically sound, comfortable to use, and
can withstand the pulling force of a dog.’, “Product Tester”: ‘Responsible for testing the
prototype dog leash in various winter conditions, ensuring it meets safety standards, is
user-friendly, and performs as intended.’}
Project Plan: the team should collaborate to design a dog leash that is functional,
visually appealing, and suitable for nighttime use in winter conditions the first step is for
the industrial designer to create a design concept that incorporates the necessary features.
Stage 1: the project team is in the initial stages of designing a dog leash for nighttime
use in winter conditions. The industrial designer is currently creating a design concept
that meets the required features.
Stage 2: Project Strategy: the next step in the project is for the industrial designer to
finalize the design concept and create detailed specifications and technical drawings for
the dog leash this will lead to the outcome of having a complete and accurate design
concept, along with specifications and technical drawings that will serve as a guide for
manufacturing the dog leash.
Stage 3: Project Strategy: the next step in the project is for the industrial designer to
finalize the design concept and create detailed specifications and technical drawings for
the dog leash. This outcome will provide a finalized design concept with detailed
specifications and technical drawings that meet the requirements for a dog leash suitable
for nighttime use in winter conditions. It will serve as a foundation for the material
scientist to select and test suitable materials, the electronic engineer to integrate
illumination technology, the mechanical engineer to ensure mechanical soundness, and
the product tester to evaluate safety standards and usability. This progress brings us
closer to achieving our goal of designing and developing a dog leash for walking the dog
at night in the winter.
Stage 4: Project Strategy: 1. Conduct research and identify materials known for
durability, weather resistance, and visibility in low light conditions. Outcome: Finalized
selection of suitable materials for the dog leash. 2. Consult with suppliers and
manufacturers to source samples of potential materials. Outcome: Obtained samples of
selected materials for testing. 3. Test materials for durability, weather resistance, and
visibility in simulated winter conditions. Outcome: evaluation of materials' performance
and suitability for winter walks. 4. Analyze test results and select the most suitable
material for the dog leash. Outcome: Clear understanding and agreement on the chosen
material for the dog leash. By completing these steps, we will ensure that the dog leash
is made from a durable, weather resistant material that provides enhanced visibility
during nighttime walks in the winter.
Stage end: project completed

If the collaboration tool determines the project is not completed, the project can move on to the next stage. Here, the updated versions of the task log data resource structure, the project status structure, and the project plan structure become the current versions. These current versions can then be used to repeat the processes to update the project structure for the current stage, as described at flow 630, flow 640, flow 650, flow 660, and flow 670.

During any of the one or more stages, the user can be provided with a set of options, such as, but not limited, the option to continue with the original plan, suggest a different next step, update the objective, or ask a question at each stage of the project.

The user can provide input indicating the desired option and the collaboration can receive that input. For example, the collaboration tool can receive an indication of an updated project objective for the project structure. In some cases, the indication of the project objective for the project structure can be received from a first user and the indication of the updated project objective for the project structure can be received from a second user, where the first user and the second user are different users. When the collaboration tool receives the indication of an updated project objective for the project structure, the collaboration tool can update the project status structure.

As another example, the collaboration tool can receive an indication of a question for the one of the agent objects to answer. Here, a user can interrogate any of the agent objects. The agent object can look at the agent object's own memory (e.g., the agent object's agent-specific task tracking data resource structure maintaining indicators of agent-specific completed tasks) and skillset to determine an answer. Indeed, a given agent object can be specifically asked a question and that given agent can use their own memory to determine an answer while not getting confused with every other agent object's memory.

As previously described, advantageously, by creating a working memory for each agent object, the chain of thought, reasoning, and planning of the agent per stage of the project can be tracked, allowing for better state maintenance and context, which facilitates use of the LLM for a long-running process, and providing transparency into the system and underlying processes that would otherwise be a black box, for a user who interacts with the agent.

To answer the question, the collaboration tool can read the indicators of the agent-specific completed tasks from the agent-specific task tracking data resource structure of the given agent. The collaboration tool can then generate a question prompt based at least in part on the indicators of the agent-specific completed tasks, the question, the project objective structure, and the project status structure.

As an example, the question prompt can include “You are a {self.role}. Your job is {self.job} working on {goal}. The overall status of the project is {status}” as the system content and “The project stakeholder is asking you this question {question}. Answer it based on your {completed_tasks}. Be concise.” as the user content. Here, the user is the agent object and {self.role}, {self.job}, {status}, {question}, and {completed_tasks} contains the context passed to the LLM.

The collaboration tool can communicate the question prompt to the LLM and receive an answer to the question from the LLM. The collaboration tool can provide the answer to the question for display.

Returning to the illustrative example of Project Nightleash, the user can interrogate the Industrial Designer agent object by asking “What is the inspiration behind your design?” The Industrial Designer answers the question based on their specific memory. Here, the answer to the question can include “The inspiration behind the design is to create a dog leash that prioritizes functionality, visibility, and durability for nighttime use in winter conditions. By researching existing designs and materials, we aim to develop a design concept that incorporates these key features, ensuring the leash is both aesthetically appealing and suitable for the intended use. Through testing and refinement, we will create a finalized design concept and detailed specifications that will guide the manufacturing process.”

In the illustrative example Project Nightleash, the user can also interrogate the Mechanical Engineer by asking “Are you getting along with the team?” The Mechanical Engineer answers the question based on their specific memory. Here, the answer to the question can include “Yes, I am working well with the team. We have been collaborating closely with the industrial designer to discuss and finalize the design concept for the dog leash. I have provided input on the necessary materials for durability, weather resistance, and low light possibility. We have reviewed and provided feedback on the design concept proposed by the industrial designer, and I am currently working on creating detailed specifications and technical drawings for the dog leash. Overall, our collaboration has been productive and efficient.”

As yet another example of the user providing input, the collaboration tool can provide the project report file for display. As previously described, the project report file can provide a record of progress for the project structure and can include the project objective structure, indicators of the project team, the current stage of the one or more stages, the current version of the project plan structure, and the project status structure.

The collaboration tool can receive an indication of a different next stage of the project and can update the project plan structure to include the different next stage of the project.

FIG. 7 illustrates a generalized example of a suitable computing system 700 in which the described innovations may be implemented. The computing system 700 is not intended to suggest any limitation as to scope of use or functionality, as the innovations may be implemented in diverse general-purpose or special-purpose computing systems.

Referring to FIG. 7, the computing system 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing system 700 includes storage 740, one or more input devices 750, one or more output devices 760, and one or more communication connections 770. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 may be removable or non-removable, and includes magnetic disks, magnetic tapes or cassettes, CD-ROMs, DVDs, or any other medium which can be used to store information and which can be accessed within the computing system 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing system 700. For video encoding, the input device(s) 750 may be a camera, video card, TV tuner card, or similar device that accepts video input in analog or digital form, or a CD-ROM or CD-RW that reads video samples into the computing system 700. The output device(s) 760 may be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

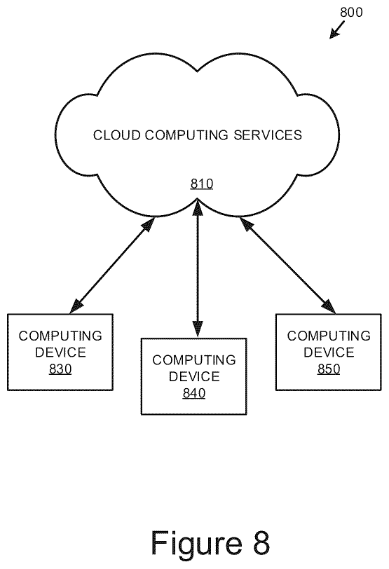

FIG. 8 illustrates a generalized example of a suitable cloud-supported environment 800 in which described embodiments, techniques, and technologies may be implemented. In the example environment 800, various types of services (e.g., computing services) are provided by a cloud 810. For example, the cloud 810 can comprise a collection of computing devices, which may be located centrally or distributed, that provide cloud-based services to various types of users and devices connected via a network such as the Internet. The implementation environment 800 can be used in different ways to accomplish computing tasks. For example, some tasks (e.g., processing user input and presenting a user interface) can be performed on local computing devices (e.g., connected devices 830, 840, 850) while other tasks (e.g., storage of data to be used in subsequent processing) can be performed in the cloud 810.

In example environment 800, the cloud 810 provides services for connected devices 830, 840, 850 with a variety of screen capabilities. Connected device 830 represents a device with a computer screen (e.g., a mid-size screen). For example, connected device 830 could be a personal computer such as desktop computer, laptop, notebook, netbook, or the like. Connected device 840 represents a device with a mobile device screen (e.g., a small size screen). For example, connected device 840 could be a mobile phone, smart phone, personal digital assistant, tablet computer, and the like. Connected device 850 represents a device with a large screen. For example, connected device 850 could be a television screen (e.g., a smart television) or another device connected to a television (e.g., a set-top box or gaming console) or the like. One or more of the connected devices 830, 840, 850 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 800. For example, the cloud 810 can provide services for one or more computers (e.g., server computers) without displays.

Services can be provided by the cloud 810 through service providers (not depicted), or through other providers of online services (not depicted). For example, cloud services can be customized to the screen size, display capability, and/or touchscreen capability of a particular connected device (e.g., connected devices 830, 840, 850).

In example environment 800, the cloud 810 provides the technologies and solutions described herein to the various connected devices 830, 840, 850 using, at least in part, the service providers. For example, the service providers can provide a centralized solution for various cloud-based services. The service providers can manage service subscriptions for users and/or devices (e.g., for the connected devices 830, 840, 850 and/or their respective users).

We claim:

1. In a computer system that implements a project management and collaboration tool, a method comprising:
initializing a project structure comprising a project plan structure and a task log data resource structure, the task log data resource structure comprising indicators of project completed tasks, wherein:
the project completed tasks comprise tasks completed by agent objects,
each of the agent objects comprises an agent-specific task tracking data resource structure maintaining indicators of agent-specific completed tasks, wherein the agent-specific completed tasks comprise tasks completed by that agent object; and
updating the project structure in one or more stages, including, for a current stage of the one or more stages:
retrieving a current version of the project plan structure for the current stage;
performing operations to complete tasks assigned to the agent objects, respectively, from the current version of the project plan structure, including, for a given agent object of the agent objects:
reading indicators of agent-specific completed tasks from the agent-specific task tracking data resource structure of the given agent object;
generating a task prompt based at least in part on a team member role of the given agent object, a distinct skillset of the given agent object, the indicators of the agent-specific completed tasks of the given agent object, and the task assigned to the given agent object from the current version of the project plan structure;
communicating the task prompt to a large language model;
receiving a task result, as a completion of the task, from the large language model; and
storing the task result in the agent-specific task tracking data resource structure as an indicator of an agent-specific completed task.

2. The method of claim 1, wherein each of the agent objects comprises a role field indicating the team member role for the agent object and a skillset field indicating the distinct skillset based on that team member role for the agent object, wherein the project structure further comprises a project objective structure and project status structure, and wherein the updating the project structure further includes, for the current stage:
updating the task log data resource structure using the agent-specific task tracking data resource structures for the agent objects, respectively, thereby producing an updated version of the task log data resource structure;
updating the project status structure using the updated version of the task log data resource structure, thereby producing an updated version of the project status structure; and
updating the project plan structure using the updated version of the task log data resource structure and the updated version of the project status structure, thereby producing an updated version of the project plan structure.

3. The method of claim 2, wherein the updating the task log data resource structure includes:
reading the indicators of the agent-specific completed tasks from the agent-specific task tracking data resource structures of the agent objects, respectively; and
storing the indicators of the agent-specific completed tasks in the updated version of the task log data resource structure as indicators of project completed tasks.

4. The method of claim 2, wherein the updating the project status structure includes:
reading indicators of project completed tasks from the updated version of the task log data resource structure;
generating a status prompt based at least in part on the indicators of the project completed tasks in the updated version of the task log data resource structure and the current version of the project plan structure;
communicating the status prompt to the large language model;
receiving, from the large language model, a status response; and
storing the status response in the updated version of the project status structure.

5. The method of claim 2, wherein the updating the project plan structure includes:
reading indicators of project completed tasks from the updated version of the task log data resource structure;
generating a plan prompt based at least in part on the indicators of the project completed tasks, the updated version of the project status structure, and the project objective structure;
communicating the plan prompt to the large language model;
receiving, from the large language model, a plan response; and
storing the plan response in the updated version of the project plan structure.

6. The method of claim 2, the method further comprising:
receiving an indication of the project objective structure for the project structure; and
generating a project team for the project structure, including:
identifying team member roles to accomplish the project objective field by:
generating a team prompt based at least in part on the project objective structure;
communicating the team prompt to the large language model; and
receiving, from the large language model, the team member roles;
creating the agent objects for the project team; and
storing indicators of the team member roles and associated role descriptions in role fields and skillset fields of corresponding ones of the agent objects.

7. The method of claim 2, wherein the updated version of the project plan structure comprises indicators of tasks for the agent objects to complete in a next stage of updating the project structure.

8. The method of claim 2, wherein, as part of the current stage, the updating of the project structure further includes, for another agent object of the agent objects, repeating the reading of the agent-specific completed tasks, the generating of the task prompt, the communicating of the task prompt, the receiving of the task result, and the storing of the task result, for the another agent object as the given agent object.

9. The method of claim 2, the method further comprising:
creating a project report file for the project structure, the project report file comprising the project objective structure, indicators of a project team, the current stage of the one or more stages, the current version of the project plan structure, and the project status structure, wherein the project report file provides a record of progress for the project structure;
updating the project report file for the project structure to include the updated version of the project status structure and the updated version of the project plan structure;
providing the project report file for display;
receiving an indication of a different next stage of the one or more stages; and
updating the project plan structure to include the different next stage of the one or more stages.

10. The method of claim 2, the method further comprising:
based on determining the updated version of the project status structure indicates a project objective has been met, generating a detailed summary report file indicating completion of the project structure, the detailed summary report file comprising a summary of each of the one or more stages; and
providing the detailed summary report file for display.

11. The method of claim 2, the method further comprising:
receiving an indication of an updated project objective for the project structure; and
updating the project status structure.

12. The method of claim 11, wherein an indication of a project objective for the project structure is received from a first user and the indication of the updated project objective for the project structure is received from a second user, wherein the first user and the second user are different users.

13. The method of claim 2, the method further comprising:
receiving an indication of a question for the given agent object of the agent objects to answer;
reading the indicators of the agent-specific completed tasks from the agent-specific task tracking data resource structure of the given agent;
generating a question prompt based at least in part on the indicators of the agent-specific completed tasks, the question, the project objective structure, and the project status structure;
communicating the question prompt to the large language model;
receiving, from the large language model, an answer to the question; and
providing the answer to the question for display.

14. One or more computer readable storage media having instructions stored thereon that, when executed by one or more processors, direct the one or more processors to perform operations comprising:
initializing a project structure comprising a project plan structure and a task log data resource structure, the task log data resource structure comprising indicators of project completed tasks, wherein:
the project completed tasks comprise tasks completed by agent objects,
each of the agent objects comprises an agent-specific task tracking data resource structure maintaining indicators of agent-specific completed tasks, wherein the agent-specific completed tasks comprise tasks completed by that agent object; and
updating the project structure in one or more stages, including, for a current stage of the one or more stages:
retrieving a current version of the project plan structure for the current stage;
performing operations to complete tasks assigned to the agent objects,
respectively, from the current version of the project plan structure, including, for a given agent object of the agent objects:
reading indicators of agent-specific completed tasks from the agent-specific task tracking data resource structure of the given agent object;
generating a task prompt based at least in part on a team member role of the given agent object, a distinct skillset of the given agent object, the indicators of the agent-specific completed tasks of the given agent object, and the task assigned to the given agent object from the current version of the project plan structure;
communicating the task prompt to a large language model;
receiving a task result, as a completion of the task, from the large language model; and
storing the task result in the agent-specific task tracking data resource structure as an indicator of an agent-specific completed task.

15. The media of claim 14, wherein each of the agent objects comprises a role field indicating the team member role for the agent object and a skillset field indicating the distinct skillset based on that team member role for the agent object, wherein the project structure further comprises a project objective structure and project status structure, and wherein the updating the project structure further includes, for the current stage:
updating the task log data resource structure using the agent-specific task tracking data resource structures for the agent objects, respectively, thereby producing an updated version of the task log data resource structure;
updating the project status structure using the updated version of the task log data resource structure, thereby producing an updated version of the project status structure; and
updating the project plan structure using the updated version of the task log data resource structure and the updated version of the project status structure, thereby producing an updated version of the project plan structure.

16. The media of claim 15, wherein the updating the task log data resource structure includes:
reading the indicators of the agent-specific completed tasks from the agent-specific task tracking data resource structures of the agent objects, respectively; and
storing the indicators of the agent-specific completed tasks in the updated version of the task log data resource structure as indicators of project completed tasks.

17. The media of claim 15, wherein the updating the project status structure includes:
reading indicators of project completed tasks from the updated version of the task log data resource structure;
generating a status prompt based at least in part on the indicators of the project completed tasks in the updated version of the task log data resource structure and the current version of the project plan structure;
communicating the status prompt to the large language model;
receiving, from the large language model, a status response; and
storing the status response in the updated version of the project status structure; and wherein the updating the project plan structure includes:
reading indicators of project completed tasks from the updated version of the task log data resource structure;
generating a plan prompt based at least in part on the indicators of the project completed tasks, the updated version of the project status structure, and the project objective structure;
communicating the plan prompt to the large language model;
receiving, from the large language model, a plan response; and
storing the plan response in the updated version of the project plan structure, the updated version of the project plan structure comprising indicators of tasks for the agent objects to complete in a next stage of updating the project structure.

18. A computer system comprising a processing system and memory, wherein the computer system is configured to perform operations comprising:
initializing a project structure comprising a project objective structure, a project status structure, a project plan structure, and a task log data resource structure, the task log data resource structure comprising indicators of project completed tasks, wherein:
the project completed tasks comprise tasks completed by agent objects,
each of the agent objects comprises an agent-specific task tracking data resource structure maintaining indicators of agent-specific completed tasks, wherein the agent-specific completed tasks comprise tasks completed by that agent object; and
updating the project structure in one or more stages, including, for a current stage of the one or more stages:
retrieving a current version of the project plan structure for the current stage;
performing operations to complete tasks assigned to the agent objects, respectively, from the current version of the project plan structure, including, for a given agent object of the agent objects:
reading indicators of agent-specific completed tasks from the agent-specific task tracking data resource structure of the given agent object;
generating a task prompt based at least in part on a team member role of the given agent object, a distinct skillset of the given agent object, the indicators of the agent-specific completed tasks of the given agent object, and the task assigned to the given agent object from the current version of the project plan structure;
communicating the task prompt to a large language model;
receiving a task result, as a completion of the task, from the large language model; and
storing the task result in the agent-specific task tracking data resource structure as an indicator of an agent-specific completed task.

19. The computer system of claim 18, wherein each of the agent objects comprises a role field indicating the team member role for the agent object and a skillset field indicating the distinct skillset based on that team member role for the agent object, wherein the project structure further comprises a project objective structure and project status structure, and wherein the updating the project structure further includes, for the current stage:
updating the task log data resource structure using the agent-specific task tracking data resource structures for the agent objects, respectively, thereby producing an updated version of the task log data resource structure;
updating the project status structure using the updated version of the task log data resource structure, thereby producing an updated version of the project status structure; and
updating the project plan structure using the updated version of the task log data resource structure and the updated version of the project status structure, thereby producing an updated version of the project plan structure.

20. The computer system of claim 19, wherein the updating the task log data resource structure includes:
reading the indicators of the agent-specific completed tasks from the agent-specific task tracking data resource structures of the agent objects, respectively; and
storing the indicators of the agent-specific completed tasks in the updated version of the task log data resource structure as indicators of project completed tasks.
